(19) United States
(12) Patent Application Publication
(10) Pub. No.: US 2024/0354577 A1
(43) Pub. Date: Oct. 24, 2024

(54) METHOD, SYSTEM, DEVICE AND STORAGE MEDIUM FOR OPERATION RESOURCE PLACEMENT OF DEEP LEARNING

(71) Applicant: ZHEJIANG LAB, Hangzhou (CN)

(72) Inventors: Yong LI, Hangzhou (CN); Laiping ZHAO, Hangzhou (CN); Zezheng MAO, Hangzhou (CN); Wen CHENG, Hangzhou (CN); Guang CHEN, Hangzhou (CN); Lingfang ZENG, Hangzhou (CN)

(21) Appl. No.: 18/374,669

(22) Filed: Sep. 29, 2023

Related U.S. Application Data
(63) Continuation of application No. PCT/CN2023/096244, filed on May 25, 2023.

(30) Foreign Application Priority Data
Apr. 19, 2023 (CN) 202310417880.1

(51) Int. Cl. G06N 3/084

(52) U.S. Cl. CPC G06N 3/084

(57) ABSTRACT

A method, a system, a device, and a storage medium for operation resource placement of deep learning are provided. The method includes: acquiring training operations to be placed and corresponding priorities; based on an order of the priorities, selecting a network structure for operation placement according to required resource amount of the training operations in sequence; the network structure including a server, a top of rack, a container group set denoted as Podset and a trunk layer switch; based on the selected network structure, taking a transmission amount of network data in a training process as an optimization target to perform minimization optimization, and obtaining a corresponding operation placement scheme.

### CROSS-REFERENCE TO RELATED APPLICATIONS

This application is a continuation of international patent application No. PCT/CN2023/096244, filed on May 25, 2023, which itself claims priority to Chinese patent applications No. 202310417880.1, filed on Apr. 19, 2023, titled “METHOD, SYSTEM, DEVICE AND STORAGE MEDIUM FOR OPERATION RESOURCE PLACEMENT OF DEEP LEARNING”. The content of the above application is hereby incorporated by reference.

### TECHNICAL FIELD

The present disclosure generally relates to a technical field of computer resource scheduling, and in particular, to a method, a system, a device, and a storage medium for operation resource placement of deep learning.

### BACKGROUND

In recent years, deep learning has been commonly applied in many data-driven application domains in a variety of industries ranging from autonomous driving to medical devices, and the deep learning includes training tasks such as an object detection, a language modeling, and a speech recognition. Processing resources such as a GPU (Graphics processing Unit) may be very efficient in processing deep learning operations. However, at present, the GPU on a single node is usually unable to cope with massive amounts of training data, and thus a distributed architecture is commonly applied in a deep learning task. In most cluster schedulers, a minimum granularity for allocating GPUs is always an overall GPU, and a resource allocation with such granularity ultimately leads to low resource utilization of a cluster.

At present, attempts are made in most clusters to fully integrate training operations of deep learning to servers with a sufficient number of processing resources in the clusters, so as to reduce network communication to indirectly improve resource utilization. However, such a unified operation placement strategy may produce idle resources, and not effectively utilize cluster resources, resulting in low resource utilization.

For the issue of uniform resource placement of training operations in the related art leading to low resource utilization, no effective solution is proposed.

### SUMMARY

According to various embodiments of the present disclosure, a method, a system, a device, and a storage medium for operation resource placement of deep learning are provided.

In a first aspect, a method for operation resource placement of deep learning is provided in an embodiment. The method includes: acquiring training operations to be placed and corresponding priorities; based on an order of the priorities, selecting a network structure for operation placement according to required resource amount of the training operations in sequence; and based on the selected network structure, taking a transmission amount of network data in a training process as an optimization target to perform minimization optimization, and obtaining a corresponding operation placement scheme. The network structure includes a server, a top of rack, a container group set denoted as Podset, and a trunk layer switch.

In some embodiments, the acquiring training operations to be placed and corresponding priorities further includes: classifying the training operations entering a cluster and adjusting resources of the training operations; and determining the priorities of the training operations according to a classification of the training operations and placing the training operations into a queue of training operations.

In some embodiments, the based on the order of the priorities, selecting the network structure for operation placement according to required resource amount of the training operations in sequence further includes: dividing cluster resources according to the number of network hops to obtain a multi-layer network structure; extracting, from the queue of training operations, the training operations to be placed according to the priorities; and selecting, layer by layer, the network structure adapted to the required resource amount of the training operations, based on a resource amount in each layer of the network structure.

In some embodiments, the based on the selected network structure, taking the transmission amount of network data in the training process as the optimization target to perform minimization optimization, and obtaining the corresponding operation placement scheme further includes: indicating the transmission amount of network data in the training process based on parameter servers, workers, and the number of parameters of each training operation jointly, and obtaining the optimization target; establishing an optimization model of the transmission amount of network data based on the optimization target and a capacity of processing resources in a cluster as an optimization constraint; and based on an optimization result of the optimization model of the transmission amount of network data, assigning the number of the parameter servers and the number of the workers, and processing resources of the parameter servers and processing resources of the workers, to each training operation in the network structure to obtain the operation placement scheme.

In some embodiments, after the obtaining the operation placement scheme, the method further includes: when a plurality of training operations share the same processing resource, obtaining a raw time of the training operations by fitting, and obtaining a training time for an entire processing resource by normalization.

In some embodiments, the obtaining the raw time of the training operations by fitting further includes: obtaining the raw time by measuring a forward propagation time and a backpropagation time of the training operations and fitting the forward propagation time and the backpropagation time of the training operations in conjunction with a gradient aggregation time.

In some embodiments, the method further includes: establishing an overall scheduling algorithm of the training operations based on the number of remaining services required for the training operations and a capacity of processing resources in a cluster as an optimization constraint; and periodically traversing processing resources of the training operations based on the overall scheduling algorithm of the training operations and obtaining an optimization result with a minimum number of remaining services.

In a second aspect, a system for operation resource placement of deep learning is provided in an embodiment. The system for operation resource placement of deep learning includes: a training operation acquiring module, a priority order placement module, and an operation placement optimization module. The training operation acquiring module is configured for acquiring training operations to be placed and corresponding priorities. The priority order placement module is configured for selecting a network structure for operation placement according to required resource amount of the training operations in sequence based on an order of the priorities. The network structure includes a server, a top of rack, a container group set denoted as Podset, and a trunk layer switch. The operation placement optimization module is configured for taking a transmission amount of network data in a training process as an optimization target to perform minimization optimization based on an order of the priorities, and obtaining a corresponding operation placement scheme.

In a third aspect, a computer device provided in an embodiment includes a processor and a memory. A computer program is stored by the memory and executable by the processor to implement the steps of the method for operation resource placement of deep learning in the first aspect.

In a fourth aspect, a computer-readable storage medium provided in an embodiment has stored a computer program. The computer program is executed by a processor to implement the steps of the method for operation resource placement of deep learning in the first aspect.

Details of one or more embodiments of the present disclosure are set forth in the following accompanying drawings and description in order to make the other features, purposes, and advantages of the present disclosure more concise and understandable.

### BRIEF DESCRIPTION OF THE DRAWINGS

In order to more clearly illustrate the technical solutions in the embodiments of the present disclosure or the related art, the accompanying drawings to be used in the description of the embodiments or the related art will be briefly introduced below, and it will be obvious that the accompanying drawings in the following description are only some of the embodiments of the present disclosure, for one skilled in the art, other accompanying drawings can be obtained based on these accompanying drawings without creative labor.

FIG. 1 is a block diagram of a hardware structure of a terminal of a method for operation resource placement of deep learning in an embodiment of the present disclosure.

FIG. 2 is a flowchart of a method for operation resource placement of deep learning in an embodiment of the present disclosure.

FIG. 3 is a schematic diagram of a multi-layer network structure in a cluster in an embodiment of the present disclosure.

FIG. 4 is a schematic diagram of a deployment architecture of training operations under a spatial partitioning strategy in an embodiment of the present disclosure.

FIG. 5 is a flowchart of a method for operation resource placement of deep learning in an alternative embodiment of the present disclosure.

FIG. 6 is a block diagram of a system for operation resource placement of deep learning in an embodiment of the present disclosure.

In the figures, 102 represents a processor, 104 represents a memory, 106 represents a transmission device, 108 represents an input and output device, 10 represents a training operation acquiring module, 20 represents a priority order placement module, and 30 represents an operation placement optimization module.

### DETAILED DESCRIPTION OF THE EMBODIMENT

Technical solutions in embodiments of the present disclosure will be clearly and completely described below with reference to the accompanying drawings in the embodiments of the present disclosure. Obviously, the described embodiments are a part of the embodiments of the present disclosure, and not all the embodiments. Based on the embodiments in the present disclosure, all other embodiments obtained by a person skilled in the art without creative labor fall within the scope of protection of the present disclosure.

Unless otherwise defined, all technical and scientific terms used herein have the same meaning as a skilled person in the art would understand. The term “one”, “a”, “an”, “the”, “these” and other similar words as used in the present disclosure do not indicate quantitative limitations, and they can be singular or plural. The terms “include”, “comprise”, “have”, and any variation thereof, as used in the present disclosure, are intended to cover a non-exclusive inclusion. For example, processes, methods and systems, and products or devices including a series of steps or modules (units) are not limited to listed steps or modules (units), but may include steps or modules (units) not listed, or may include other steps or modules (units) inherent in those processes, methods, products or devices. The terms “connection”, “connected”, “coupling”, and other similar words as used in the present disclosure are not limited to physical or mechanical connections, but may include electrical connections, which can be direct connections or indirect connections. The term “plurality” in the present disclosure refers to two or more. “And/or” describes an association relationship between associated objects, indicating that there can be three kinds of relationships. For example, “A and/or B” can mean that A exists alone, A and B exist at the same time, and B exists alone. Typically, a character “/” indicates that objects associated before and after are in an “or” relationship. The terms “first”, “second”, “third”, etc. involved in the present invention are only configured for distinguishing similar objects, and do not represent a specific order of the objects.

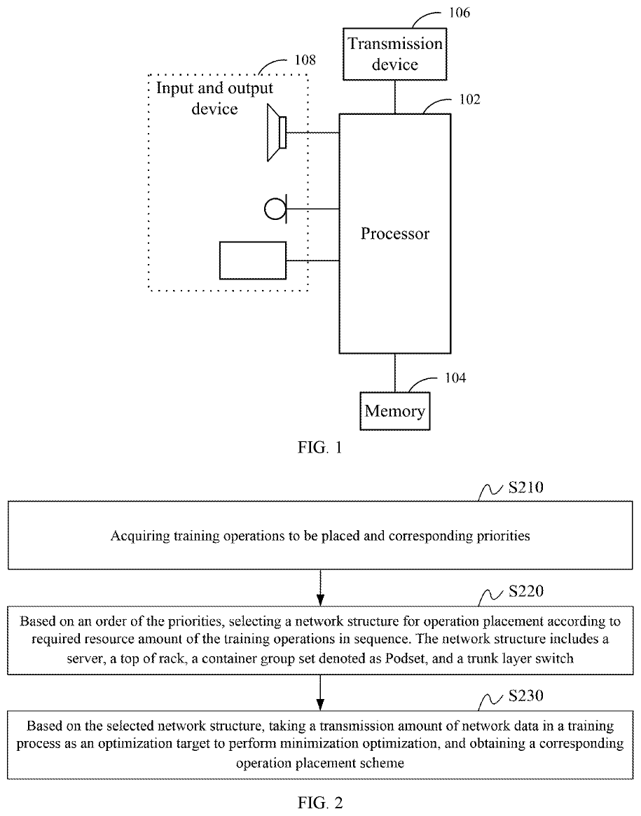

The embodiments of a method provided in the present disclosure may be executed in a terminal, a computer, or a similar computing device. As an example, running on a mobile terminal, and FIG. 1 is a block diagram of a hardware structure of a terminal of a method for operation resource placement of deep learning in an embodiment of the present disclosure. Referring to FIG. 1, the terminal may include one or more (only one is shown in FIG. 1) processors 102 (the processor 102 may include, but is not limited to, a processing device such as a Micro Control Unit (MCU), a Field Programmable Gate Array (FPGA), etc.) and a memory 104 for storing data. The terminal may also include a transmission device 106 for a communication function and an input and output device 108. As may be understood by those skilled in the art, the structure shown in FIG. 1 is merely schematic, and it does not limit the structure of the above-described terminal. For example, the terminal may also include more or fewer components than that shown in FIG. 1, or have a configuration different from that shown in FIG. 1.

The memory 104 is configured to store a computer program, e.g., a software program and module of an application software, such as a computer program corresponding to the method for operation resource placement of deep learning in an embodiment of the present disclosure. The processor 102 may perform various functional applications as well as data processing, i.e., realize the above-described method, by running the computer program stored in the memory 104. The memory 104 may include a high-speed random memory, and may also include a non-volatile memory, such as one or more magnetic storage devices, flash memories, or other non-volatile solid-state memories. In some embodiments, the memory 104 may further include memories set remotely relative to the processor 102, and these remote memories may be connected to the terminal via a network. Examples of the network may include, but are not limited to, the Internet, an enterprise intranet, a local area network, a mobile communication network, and combinations thereof.

The transmission device 106 is configured to receive or send data via a network. Specific examples of the network described above may include a wireless network provided by a communication provider of the terminal. In an embodiment, the transmission device 106 may include a Network Interface Controller (NIC) that may be connected to other network devices via a base station so that it may communicate with the Internet. In an embodiment, the transmission device 106 may be a Radio Frequency (RF) module for communicating with the Internet wirelessly.

In recent years, deep learning has been commonly applied in many data-driven application domains in a variety of industries ranging from autonomous driving to medical devices, and the deep learning includes training tasks such as an object detection, a language modeling, and a speech recognition. Processing resources such as a GPU (Graphics processing Unit) may be very efficient in processing highly parallelizable matrix operations in the operations of deep learning and has been commonly applied in model training of deep learning. However, at present, the GPU on a single node is usually unable to cope with massive amounts of training data, and thus a distributed architecture is commonly applied in a deep learning task. In most cluster schedulers, a minimum granularity for allocating GPUs is always an overall GPU, i.e., an application may use multiple GPUs, but each GPU may be assigned to only one application, and a resource allocation with such granularity ultimately leads to low resource utilization of a cluster.

At present, attempts are made in most clusters to fully integrate training operations of deep learning to servers with a sufficient number of processing resources in the clusters, so as to reduce network communication to indirectly improve resource utilization. However, such a unified operation placement strategy may produce idle resources, and not effectively utilize cluster resources, resulting in low resource utilization.

To solve the above problem, a method, a system, a device, and a storage medium for operation resource placement of deep learning are provided in the following embodiments, which may take a transmission amount of network data in a training process as an optimization target, obtain a corresponding operation placement scheme for different network structures selected for placement of the training operations, and improve utilization of resources in the cluster by effectively reducing data transmission in the network.

A method for operation resource placement of deep learning is provided in the present embodiment, FIG. 2 is a flowchart of the method for operation resource placement of deep learning in the present embodiment, and referring to FIG. 2, the method includes steps 210 to 230.

Step 210 includes acquiring training operations to be placed and corresponding priorities.

Specifically, after a stream of training operations to be placed enters an intelligent computing cluster, the cluster may divide the training operations into a predictable operation and an unpredictable operation, set different priorities for the two types of operations, and queue the two types of operations into a queue of training operations where the priorities have been set by default.

Step 220 includes based on an order of the priorities, selecting a network structure for operation placement according to required resource amount of the training operations in sequence. The network structure includes a server, a top of rack, a container group set denoted as Podset, and a trunk layer switch.

Specifically, based on the order of the priorities, the training operations may be sequentially taken out from the training operation queue, be put into the cluster, and be placed in an adapted network structure to perform.

For each training operation that is taken from the training operation queue and enters the cluster, the training operation may be prioritized to be placed in a server based on the required resource amount of the training operation, and the adapted network structure capable of accommodating the training operation may be selected layer-by-layer in an order of the server, the top of rack, the container group set Podset, and the trunk layer switch for placement of the training operation.

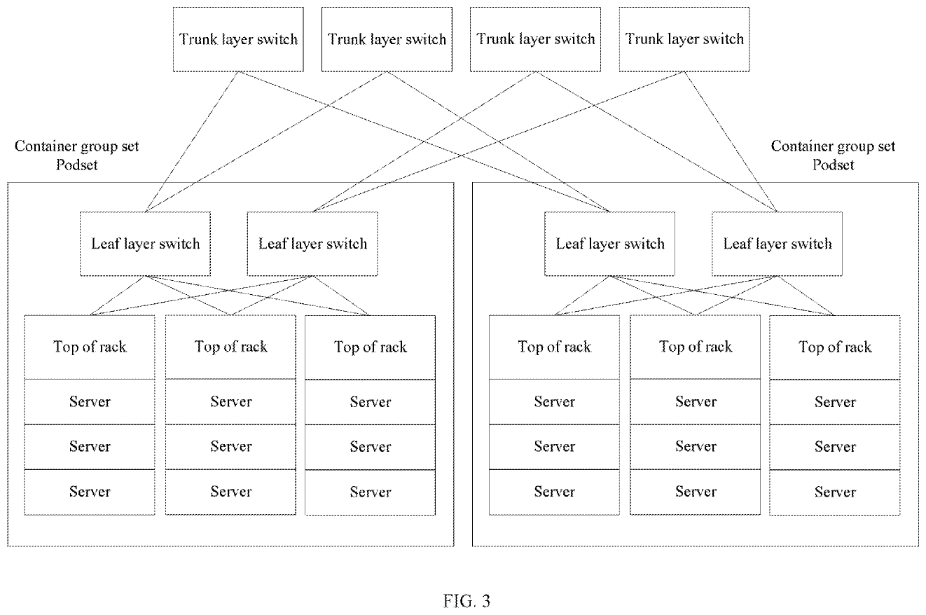

A multi-layer network structure may be obtained by dividing the cluster resources, and FIG. 3 is a schematic diagram of the multi-layer network structure in the cluster in the present embodiment. Referring to FIG. 3, a number of servers in a first layer may be connected to a top of rack (ToR) in a second layer, each top of rack and a number of servers connected thereto may form a POD (Container group), and the top of rack may be connected to a leaf layer switch. These servers, top of racks, and leaf layer switches may form a Podset (container group set) at a third layer, and a number of Podsets may be connected to trunk layer switches at a fourth layer, forming the multilayer network structure of the cluster.

Step 230 includes based on the selected network structure, taking a transmission amount of network data in a training process as an optimization target to perform minimization optimization, and obtaining a corresponding operation placement scheme.

Specifically, time of data transmission process may be fixed for each training operation during the training process and be determined by allocation of processing resources. For example, under a mechanism of Tensorflow (distributed machine learning platform), the time of the data transmission process may include time of forwarding, backwarding, and updating processes on a parameter server (PS) and a worker. In this case, the forwarding refers to a process in which each worker transmits computed gradient values to each parameter server, the backwarding (backpropagation) refers to backpropagation use a prediction error given by forwarding propagation to compute gradient values for parameters of each layer, and the updating refers to a process in which each parameter server is updated based on the gradient values.

In a case where the time of the data transmission process is fixed, overall data transmission time may be reduced by reducing the transmission amount of network data during the training process. In a network structure that is adapted to the required resource amount of the training operations, the transmission amount of network data during the training process may be taken as an optimization target, and the corresponding operation placement schemes under different network structures may be obtained by adjusting placement of parameter servers and workers of the training operations to reduce overall transmission amount of network data.

At the above steps, an adapted network structure may be selected based on the required resource amount of the training operations, a transmission amount of network data in a training process may be taken as an optimization target, and a corresponding operation placement scheme for different network structures may be obtained by adjusting placement of training operations. Compared to a scheme of uniformly placing an entire operation in a server in the related art, the present embodiment may minimize and optimize the transmission amount of network data in the training process for different network structures selected for placement of the training operations, to obtain the corresponding operation placement scheme, improving utilization of resources in the cluster by effectively reducing data transmission in the network, and solving the problem of low resource utilization due to uniform resource placement of training operations.

In some embodiments, at the step 210, the acquiring training operations to be placed and corresponding priorities may further include step 211 and step 212.

Step 211 may include classifying the training operations entering a cluster and adjusting resources of the training operations.

Step 212 may include determining the priorities of the training operations according to a classification of the training operations and placing the training operations into a queue of training operations.

Specifically, the cluster may classify the training operations into a predictable operation and an unpredictable operation, set different priorities and resource adjustment schemes for the two types of operations, and queue the two types of operations into a training operation queue where the priorities have been set by default. For the predictable operation, a gain of resource adjustment may tend to be predictable, so each adjustment may bring gain to the cluster. For the unpredictable operation, a gain may be usually unpredictable, and blind resource adjustment for the unpredictable operation may usually bring negative gain to the cluster. In addition, the predictable operation and the unpredictable operation may be prioritized differently, the predictable operation may be prioritized by taking into account both resource adjustment and completion time of remaining operation, and the unpredictable operation may be prioritized by the number of services that the unpredictable operation has received.

In the present embodiment, after the training operations is classified, corresponding priorities of the training operations may be obtained, and the training operations may be queued into the queue of training operations. The training operations may be performed according to corresponding priorities when the training operations enter the cluster, maximizing utilization of cluster resources.

In some embodiments, at the step 220, the based on the order of the priorities, selecting the network structure for operation placement according to required resource amount of the training operations in sequence may further include step 221 to step 223.

Step 221 may include dividing cluster resources according to the number of network hops to obtain a multi-layer network structure.

Specifically, the number of network hops may be a distance in a routing protocol, specifically expressed as the number of routers passed through to a destination network (a server). When passing through one router, the number of network hops may be increased by 1. Based on the number of network hops, the cluster resources may be divided into the same server, the same top of rack, the same container group set Podset, and the same trunk layer switch, and a multi-layer network structure may be obtained. Taking the schematic diagram of the multi-layer network structure in the cluster of FIG. 3 of the above embodiments as an example, the server, the top of rack, and the leaf layer switch connected at the top in FIG. 3 belong to the same container group set Podset.

Step 222 may include extracting, from the queue of training operations, the training operations to be placed according to the priorities.

Specifically, based on the priorities of the training operations in the queue of training operations, the training operations to be placed may be sequentially extracted into the cluster for operation placement and execution.

Step 223 may include selecting, layer by layer, the network structure adapted to the required resource amount of the training operations, based on a resource amount in each layer of the network structure.

Specifically, based on the required resource amount of the training operations and the resource amount in each layer of the network structure, the network structure that can accommodate the training operations may be selected. When the resource amount in a previous layer of the network structure does not match the required resource amount of the training operations, the training operations would be placed in a latter layer of the network structure, and the network structure may be selected layer-by-layer in an order of the server, the top of rack, the container group set Podset, and the trunk layer switch for placement of the training operations.

In order to reduce network transmissions among different layers of the network structure, the training operations may be prioritized to be placed in a server with a maximum load, specifically an adapted server that may be selected by a best-fit algorithm. When a server does not have sufficient resource amount to accommodate the training operations, the training operations may be further dispersed across a plurality of servers in an adapted network structure. Referring to FIG. 3, when the resource amount of a server in the first layer is insufficient, further attempts may be made to disperse the training operations in the plurality of servers under the same top of rack, or else the training operations may be further dispersed in the plurality of servers under the same container group set Podset, and similarly dispersion may be performed in the same trunk layer switch.

Furthermore, when the training operations are dispersed in different servers, total parameter servers and workers of the training operations may be prioritized to be placed uniformly in the plurality of servers. When the plurality of servers do not have the same amount of available resources, the parameter servers and the workers of the training operations may be placed in a corresponding proportion according to the available resources in different servers.

A specific placement scheme of the training operations, staged layer by layer, may be given below:
(1) when a server with sufficient processing resources exists to accommodate entire training operations, the entire training operations may be placed in the server with a largest load, specifically the server that may satisfy operation requirement and have a least free partition from total free regions by a best-fit algorithm. Otherwise, the training operations may need to be placed in the plurality of servers.
(2) In order to avoid network transmission in the leaf layer switch and the trunk layer switch, it is attempted that whether placing the training operations in a rack (i.e., within a container group set Podset). If yes, the parameter servers and workers of the training operations may be uniformly distributed across the plurality of servers in the rack. When the plurality of servers do not have the same amount of available resources, the parameter servers and the workers of the training operations may be placed in a corresponding proportion according to the available resources in the plurality of servers.
(3) When a system is too busy or the model is too large, and no rack exists that is adapted to the training operations, Podset level distribution (i.e., placed in different Podsets under the trunk layer switch) may be applied, and the parameter servers and workers of the training operations may be placed in servers of the container group set Podset in proportion according to available resources.

In the present embodiment, an adapted network structure for operation placement may be selected based on the required resource amount of the training operations and resource amount of the network structure in the cluster. This is not limited to a solution of placing the entire training operations in a single server. The present embodiment can improve flexibility of operation placement, and the adapted network structure that can accommodate the training operations may be selected sequentially with a hierarchy of the network structure including the server, the top of rack, the container group set Podset, and the trunk layer switch. The present embodiment can minimize network transmissions among the network structures with different hierarchies.

In some embodiments, at the step 230, the based on the selected network structure, taking the transmission amount of network data in the training process as the optimization target to perform minimization optimization, and obtaining a corresponding operation placement scheme may further include step 231 to step 233.

Step 231 may include indicating the transmission amount of network data in the training process based on parameter servers, workers, and the number of parameters of each training operation jointly, and obtaining the optimization target.

Specifically, the transmission amount of network data during the training process may come from processes such as parameter transfer between the parameter servers and the workers during the training process, and the transmission amount of network data may be specifically represented by each parameter server, worker, and parameter count, which may also include the servers where the parameter servers and workers are located, and the number of network hops among the servers. Since the time of data transfer process is fixed for each training operation during the training process, as determined by the allocation of processing resources, the transmission amount of network data may be taken as an optimization target to adjust placement of the parameter servers and the workers of the training operations to reduce transmission amount of network data during the training process and overall data transfer time.

At step 232, establishing an optimization model of the transmission amount of network data based on the optimization target and a capacity of processing resources in a cluster as an optimization constraint.

Specifically, after establishing the optimization target, it is also necessary to ensure that the allocation of processing resources in the cluster does not exceed an available capacity in each server. The processing resources may include, but are not limited to, CPU (Central Processing Unit) and GPU (Graphics Processing Unit). The optimization model for the transmission amount of network data may be established based on the capacity of processing resources as the optimization constraint.

Assuming that given a set of training operations, each training operation is configured with resources such as the number of the parameter servers, the number of the workers, the number of GPU cores per worker, the number of CPU cores per parameter server, and the number of CPU cores per worker.

Since operation training process of deep learning includes a plurality of iterations and similar processing is performed in each iteration, the transmission amount of network data during the training process may be categorized as the transmission amount of data in each iteration during the training.

A representation of the optimization model of the transmission amount of network data may be given as follows:

$$min . {\sum }_{i ∈ I} {\sum }_{s ∈ {P}_{i}} {\sum }_{k ∈ {W}_{i}} {\sum }_{o ∈ O} {\sum }_{n ∈ O} {x}_{so} {x}_{kn} {h}_{on} \frac{{M}_{i}}{\vert {P}_{i} \vert}$$

In the optimization target of the above formula, hₒₙ represents the number of network hops from a server denoted as o to a server denoted as n, and xₛₒ and xₖₙ represent binary variables that denote whether a parameter server s of a training operation i is in the server o and whether the worker k of the training operation i is in the server n, respectively, if yes, the binary variable is 1, otherwise, the binary variable is 0. Pᵢ and Wᵢ represent a set of parameter servers s of the training operation i and a set of workers k of the training operation i, respectively. Mᵢ represents the number of parameters input to a deep learning neural network. I represents a set of the training operations, and O represents a set of servers.

The optimization constraint to ensure that the allocation of processing resources in the cluster does not exceed the available capacity in each server may be as follows:

$${\sum }_{i ∈ I} ( {\sum }_{s ∈ {P}_{i}} {x}_{so} {u}_{p}^{s} + {\sum }_{k ∈ {W}_{i}} {x}_{ko} {u}_{w}^{k} ) \leq {C}_{o} , ∀ o ∈ O$$

$${\sum }_{i ∈ I} {\sum }_{k ∈ {W}_{i}} {x}_{ko} {g}_{k} \leq {G}_{o} , ∀ o ∈ O$$

In the above formulas, xₛₒ and xₖₒ represent whether the parameter server s and the worker k of the training operation i is in the server o, respectively, uₛₚ and u_{kw} represent the number of CPU cores of each parameter server s and each worker k, respectively, gₖ represents the number of GPU cores assigned to the worker k, Cₒ represents a sum of CPU resources in the server o, and Gₒ represents a sum of GPU resources in the server o.

In addition, the training operations may also be constrained to be placed in the server o by the following optimization constraint:

$${\sum }_{o ∈ O} {x}_{so} = 1 , ∀ i ∈ {P}_{i} ⋃ {W}_{i} , ∀ i ∈ I$$

As well as performing the following domain constraints:
Xₛₒ, Xₖₙ∈{0,1}, ∀s, k, o, n

The parameters in the above formula have the same meaning as above.

Step 233 may include based on an optimization result of the optimization model of the transmission amount of network data, assigning the number of the parameter servers and the number of the workers, and processing resources of the parameter servers and processing resources of the workers, to each training operation in the network structure to obtain the operation placement scheme.

Specifically, the optimization result of a minimum transmission amount of network data during training process may be obtained by minimizing the transmission amount of network data, so that the placement scheme of the training operations may be obtained based on the optimization result. Specifically, the number of the parameter servers and the number of the workers, and the processing resources of the parameter servers and the processing resources of the workers may be assigned to each training operation, and the processing resources include the number of GPU cores and CPU cores.

In the present embodiment, the optimization model of the transmission amount of network data may be established based on the optimization target of the transmission amount of network data, combined with the optimization constraint of the capacity of processing resource. The placement scheme of the training operation may be obtained by minimizing and optimizing the model, the minimum transmission amount of network data may be achieved by adjusting the placement scheme of the training operations to reduce the transmission time of data, and the resource utilization may be improved by reducing the completion time of the training operations.

Since in most cluster schedulers currently, the minimum granularity for allocating processing resources such as GPUs is always an overall GPU, a resource allocation with such granularity ultimately leads to low resource utilization of the cluster. Based on the operation placement in the above embodiments, a space partitioning strategy is introduced to provide fine-grained scheduling of processing resources.

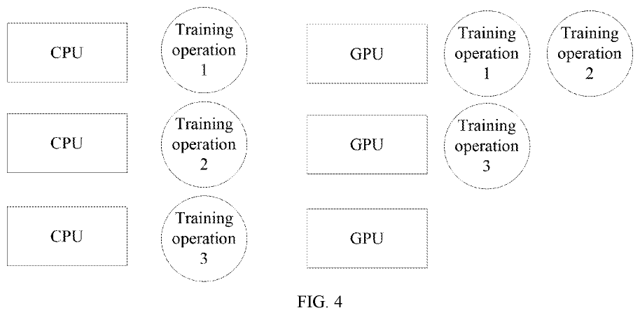

In the space partitioning strategy, a case may exist that different training operations are placed in the same processing resource GPU, which may improve utilization of GPU and fully utilize the processing resources. FIG. 4 is a schematic diagram of a deployment architecture of the training operations under the spatial partitioning strategy in the present embodiment. Referring to FIG. 4, a leftmost column of FIG. 4 represents a number of central processors (CPUs), with a right side of CPUs corresponding to different training operations deployed, respectively. A right column of FIG. 4 represents a number of graphic processors (GPUs), with a right side of GPUs corresponding to the training operations deployed. A case may exist that two different training operations are deployed in a GPU, and no training operations are deployed in a GPU or a training operation is deployed in a GPU.

When a training operation arrives in the cluster, the training operation may be given a portion of GPUs after adjustment of the optimization model and resource allocation status. At this moment, the cluster may place an operation with small requirement and an operation with large requirement in the same GPU as much as possible, so as to obtain a high utilization rate of GPU. In the above case, when the number of GPUs obtained by a worker is less than one, it indicates that other training operations spatially sharing the same processing resource. Due to a change of obtained processing resources, it is necessary to re-acquire a training time, which may be realized by the following embodiments.

In some embodiments, when a plurality of training operations share the same processing resource, a raw time of the training operations may be obtained by fitting, and a training time for an entire processing resource may be obtained by normalization.

Furthermore, the raw time may be obtained by measuring a forward propagation time and a backpropagation time of the training operations and fitting the forward propagation time and the backpropagation time of the training operations in conjunction with a gradient aggregation time.

Specifically, the raw time may include the forward propagation time and the backpropagation time of the training operations. Specifically, the raw time may be obtained by measuring the forward propagation time and the backpropagation time of the training operations and fitting the forward propagation time and the backpropagation time of the training operations in conjunction with the gradient aggregation time. For a case that a plurality of GPUs are assigned to a worker of the training operations, a local gradient aggregation operation may be introduced into the mechanism of Tensorflow. After each GPU derives gradient in the backpropagation, the gradient needs to be aggregated before transmitting to the parameter servers, and the gradient aggregation time refers to a time overhead of gradient aggregation in the training operations.

A representation of a fitting model is given below:

$${t}_{f}^{i} + {t}_{b}^{i} = {m}_{i} ( \frac{{α}_{3}}{{β}_{3} + {g}_{i}} + {γ}_{3} ) {t}_{0}^{i} + ( \frac{{α}_{4}}{{β}_{4} + {g}_{i}} + {γ}_{4} ) {t}_{a}^{i} + [ {g}_{i} ] {t}_{agg}^{i}$$

In the above formula, tⁱ_{f} represents the forward propagation time in the raw time, tⁱ_{b} represents the backpropagation time in the raw time, tⁱ₀ represents a time of one forward propagation, tⁱₐ represents a time of one backpropagation, mᵢ represents a batch size of the parameters input to the neural network each time, gᵢ represents the number of GPU cores assigned to a worker in a training operation i, tⁱ_{agg} represents a coefficient of aggregation time, and [gᵢ] represents an upward rounding of the number of GPU cores assigned less than one. Since the aggregation time is linearly correlated with the number of gradients, the gradient aggregation time may be represented as [gᵢ]tⁱ_{agg}, and α₃, α₄, β₃, β₄, γ₃, and γ₄ are parameters obtained from the fitting.

Compared to a time-sharing mechanism of time multiplexing in the related art, different training operations may be placed in the same processing resource GPU in the space partitioning strategy in the present embodiment, which can utilize the resources more efficiently in space partitioning. When other training operations share the same processing resource spatially, the raw time of the training operations may be obtained by fitting due to the change of the obtained processing resource, and the actual training time may be further obtained.

In the above embodiments, after the placement of each training operation in the network structure of the cluster, a minimum operation completion time of a single training operation may be obtained and resource utilization may be improved. Due to a long operation period of deep learning, a state of the training operations in the cluster may be continuously scanned during operation training process, and then resource placement of the training operations may be periodically adjusted with an aim of maximizing overall gain in the cluster. In order to further perform overall resource adjustment of the training operations that arrive into the cluster consecutively, an overall resource adjustment strategy of the cluster is provided in the following embodiment.

In some embodiments, the above method may further include: establishing an overall scheduling algorithm of the training operations based on the number of remaining services required for the training operations and a capacity of processing resources in a cluster as an optimization constraint; and periodically traversing processing resources of the training operations based on the overall scheduling algorithm of the training operations and obtaining an optimization result with a minimum number of remaining services.

Specifically, in order to allocate processing resources in the cluster to the training operations with high gain, the number of remaining services required for the training operations may be taken as an optimization target, combined with the capacity of the processing resources as an optimization constraint, and the overall scheduling algorithm of the training operations may be established.

During an operation of the overall scheduling algorithm of the training operations, the processing resources of the training operations may be periodically traversed at a preset period. The processing resources of the training operations may include the number of the parameter servers, the number of the workers, the number of GPU cores per worker, the number of CPU cores per parameter server, and the number of CPU cores per worker. The number of remaining services after increasing and decreasing amount of each processing resource may be calculated, respectively, and all the calculated results may be sorted to obtain the minimum number of remaining services. After the calculation of the minimum number of remaining services for each operation is obtained, an operation that produce the calculated result may be categorized. When resources are increasing, the operation may be placed in a positive benefit queue, otherwise placed in a negative benefit queue, both of which are sorted in ascending order.

A manifestation of the overall scheduling algorithm of the training operations may be given below, and the optimization target may be:

$$min : {\sum }_{i} {V}_{i}$$

The optimization constraint may be:

$${\sum }_{i} {x}_{ij} {g}_{i} \leq {G}_{j}$$

$${\sum }_{i} {x}_{ij} {v}_{i} \leq {V}_{j}$$

$${\sum }_{i} ( {w}_{i} {u}_{w}^{t} + {p}_{i} {u}_{p}^{i} ) \leq C$$

$${\sum }_{i} {\sum }_{j} {x}_{ij} {g}_{i} \leq G$$

$${p}_{i} , {w}_{i} , {g}_{i} , {u}_{p}^{i} , {u}_{w}^{i} ∈ {Z}^{+} , ∀ i$$

$${V}_{i} = {S}_{cpu}^{i} + {S}_{gpu}^{i}$$

$${S}_{cpu}^{i} = ( {w}_{i} {u}_{w}^{i} + {p}_{i} {u}_{p}^{i} ) {c}_{i}$$

$${S}_{gpu}^{i} = {x}_{ij} {g}_{i} {c}_{i}$$

In the above formulas, V represents the number of remaining services required for the training operations, j represents a group of training operations i, Sⁱ_{cpu} represents a sum of CPU resources required for the training operation i, Sⁱ_{gpu} represents a sum of GPU resources required for the training operation i, gᵢ represents the number of GPU cores assigned to the worker in the training operation i, xᵢⱼ represents a binary variable, C and G represent capacity of the processing resources CPU and GPU in the cluster, respectively, vᵢ represents the number of remaining services required for the training operation i, cᵢ represents the completion time of the training operation i, pᵢ and wᵢ represent a set of parameter servers s of the training operation i and a set of workers k of the training operation i, respectively, uᵢₚ and u_{iw} represent the number of CPU cores of parameter servers in the training operation i and the number of CPU cores of workers in the training operation i, respectively, and Z+ represents a positive integer.

In the present embodiment, the overall scheduling algorithm of the training operations may be established, which can further adjust the overall resources of the training operations that arrive into the cluster consecutively, allocate the resources to the training operations that can obtain more gain, and actively release the resources from the training operations that obtain lower gain, so as to realize maximization of the overall gain in the cluster, and effectively improve the resource utilization rate.

The present embodiment may be described and illustrated below by alternative embodiments.

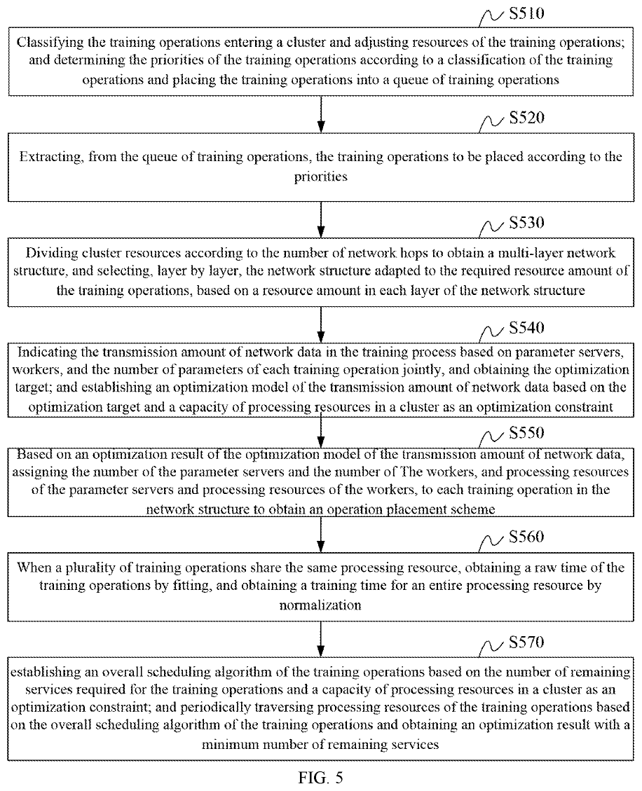

FIG. 5 is a flowchart of a method for operation resource placement of deep learning in an alternative embodiment. Referring to FIG. 5, the method may include the following step 510 to step 570.

Step 510 may include classifying the training operations entering a cluster and adjusting resources of the training operations; and determining the priorities of the training operations according to a classification of the training operations and placing the training operations into a queue of training operations.

Step 520 may include extracting, from the queue of training operations, the training operations to be placed according to the priorities.

Step 530 may include dividing cluster resources according to the number of network hops to obtain a multi-layer network structure, and selecting, layer by layer, the network structure adapted to the required resource amount of the training operations, based on a resource amount in each layer of the network structure.

The network structure may include a server, a top of rack, a container group set denoted as Podset, and a trunk layer switch.

Step 540 may include indicating the transmission amount of network data in the training process based on parameter servers, workers, and the number of parameters of each training operation jointly, and obtaining the optimization target; and establishing an optimization model of the transmission amount of network data based on the optimization target and a capacity of processing resources in a cluster as an optimization constraint.

Step 550 may include based on an optimization result of the optimization model of the transmission amount of network data, assigning the number of the parameter servers and the number of the workers, and processing resources of the parameter servers and processing resources of the workers, to each training operation in the network structure to obtain an operation placement scheme.

Step 560 may include when a plurality of training operations share the same processing resource, obtaining a raw time of the training operations by fitting, and obtaining a training time for an entire processing resource by normalization.

Step 570 may include establishing an overall scheduling algorithm of the training operations based on the number of remaining services required for the training operations and a capacity of processing resources in a cluster as an optimization constraint; and periodically traversing processing resources of the training operations based on the overall scheduling algorithm of the training operations and obtaining an optimization result with a minimum number of remaining services.

It should be noted that the steps illustrated in the above-described process or in the flowchart of the accompanying drawings may be performed in a computer system such as a set of computer-executable instructions. Although a logical order is illustrated in the flowchart, in some cases, the steps illustrated or described may be performed in a different order than herein. For example, the overall training operations may be periodically scheduled at step S570, and step S560 may be performed after each rescheduling.

In the present alternative embodiment, an adapted network structure may be selected based on the required resource amount of the training operations, a transmission amount of network data in a training process may be taken as an optimization target, and a corresponding operation placement scheme for different network structures may be obtained by adjusting placement of training operations. Compared to a scheme of uniformly placing an entire operation in a server in the related art, the present embodiment may minimize and optimize the transmission amount of network data in the training process for different network structures selected for placement of the training operations, to obtain the corresponding operation placement scheme, improving utilization of resources in the cluster by effectively reducing data transmission in the network, and solving the problem of low resource utilization due to uniform resource placement of training operations.

Furthermore, the present embodiment is not limited to a solution of placing the entire training operations in a single server. The present embodiment can improve flexibility of operation placement, and the adapted network structure that can accommodate the training operations may be selected sequentially with a hierarchy of the network structure including the server, the top of rack, the container group set Podset, and the trunk layer switch. The present embodiment can minimize network transmissions among the network structures with different hierarchies.

The present disclosure further provides a system for operation resource placement of deep learning. The system is configured to realize the above embodiments and alternative embodiments, which have already been described without further elaboration. As used hereinafter, terms “module”, “unit”, “sub-unit”, and the like may be combinations of software and/or hardware that may implement preset functions. Although the system described in the following embodiments is preferably implemented in software, implementation in hardware, or a combination of software and hardware, is also possible and contemplated.

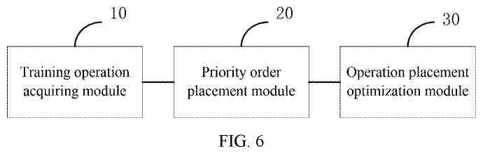

FIG. 6 is a block diagram of a system for operation resource placement of deep learning in the present embodiment. Referring to FIG. 6, the system includes a training operation acquiring module 10, a priority order placement module 20, and an operation placement optimization module 30.

The training operation acquiring module 10 is configured for acquiring training operations to be placed and corresponding priorities.

The priority order placement module 20 is configured for selecting a network structure for operation placement according to required resource amount of the training operations in sequence based on an order of the priorities. The network structure includes a server, a top of rack, a container group set denoted as Podset, and a trunk layer switch.

The operation placement optimization module 30 is configured for taking a transmission amount of network data in a training process as an optimization target to perform minimization optimization based on the selected network structure, and obtaining a corresponding operation placement scheme.

In the system of the present embodiment, an adapted network structure may be selected based on the required resource amount of the training operations, a transmission amount of network data in a training process may be taken as an optimization target, and a corresponding operation placement scheme for different network structures may be obtained by adjusting placement of training operations. Compared to a scheme of uniformly placing an entire operation in a server in the related art, the present embodiment may minimize and optimize the transmission amount of network data in the training process for different network structures selected for placement of the training operations, to obtain the corresponding operation placement scheme, improving utilization of resources in the cluster by effectively reducing data transmission in the network, and solving the problem of low resource utilization due to uniform resource placement of training operations.

It should be noted that each of the above-described modules may be a function module or a program module, and may be implemented either by software or by hardware. For modules implemented by hardware, each of the above-described modules may be disposed in the same processor, or each of the above-described modules may also be disposed in different processors in any combination.

In an embodiment, the system for operation resource placement of deep learning includes a processor, and the processor is configured to execute the following program modules stored in a memory:
a training operation acquiring module 10, configured for acquiring training operations to be placed and corresponding priorities;
a priority order placement module 20, configured for selecting a network structure for operation placement according to required resource amount of the training operations in sequence based on an order of the priorities; the network structure including a server, a top of rack, a container group set denoted as Podset, and a trunk layer switch;
an operation placement optimization module 30, configured for taking a transmission amount of network data in a training process as an optimization target to perform minimization optimization based on the selected network structure, and obtaining a corresponding operation placement scheme.

The present disclosure further provides a computer device, including a memory and a processor. The memory has a computer program stored therein, and the processor is provided to run a computer program to perform the steps in any one of the above method embodiments.

Alternatively, the computer device may further include a transmission device and an input and output device, the transmission device is connected to the above processor, and the input and output device is connected to the above processor.

It should be noted that specific examples in the present embodiment may be referred to examples described in the above embodiments and alternative embodiments, which will not be repeated in the present embodiment.

In addition, in conjunction with the method for operation resource placement of deep learning provided in the above embodiments, the present embodiment further provides a storage medium. The storage medium has a computer program stored therein, and the computer program is executed by a processor to implement any one of the methods for operation resource placement of deep learning deep in the above embodiments.

It should be noted that user information (including, but not limited to, user device information, user personal information, etc.) and data (including, but not limited to, data used for analysis, data stored, data displayed, etc.) involved in the present disclosure are authorized by the user or fully authorized by parties.

It should be understood that the specific embodiments described herein are only used to explain an application and not to qualify it. According to the embodiments provided in the present disclosure, all other embodiments obtained by one skilled in the art without creative labor are within a scope of protection of the present disclosure.

Obviously, the accompanying drawings are only some examples or embodiments of the present disclosure, and it would be possible for one skilled in the art to apply the present disclosure to other similar situations in accordance with these accompanying drawings without creative labor. Furthermore, it should be understood that although work done in this development process may be complex and lengthy, certain changes in design, manufacture or production, etc., based on the technical content disclosed in the present disclosure are only conventional technical means to one skilled in the art and should not be regarded as insufficient for the disclosure of the present disclosure.

A term “embodiment” in the present disclosure means that specific features, structures, or characteristics described in conjunction with embodiments may be included in at least one embodiment of the present disclosure. The appearance of the phrase at various locations in the specification does not necessarily imply the same embodiment, nor does it imply independence or optionality from other embodiments that are mutually exclusive. It will be clearly or implicitly understood by one skilled in the art that the embodiments described in the present disclosure may be combined with other embodiments in the absence of conflict.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are merely illustrative of several embodiments of the present disclosure, and the description thereof is relatively specific and detailed, but is not to be construed as limiting the scope of the disclosure. It should be noted that a number of variations and modifications may be made by those skilled in the art without departing from the spirit and scope of the disclosure. Therefore, the scope of the disclosure should be determined by the appended claims

What is claimed is:

1. A method for operation resource placement of deep learning, comprising:
acquiring training operations to be placed and corresponding priorities;
based on an order of the priorities, selecting a network structure for operation placement according to required resource amount of the training operations in sequence; wherein the network structure comprises a server, a top of rack, a container group set denoted as Podset, and a trunk layer switch; and
based on the selected network structure, taking a transmission amount of network data in a training process as an optimization target to perform minimization optimization, and obtaining a corresponding operation placement scheme.

2. The method for operation resource placement of deep learning of claim 1, wherein the acquiring training operations to be placed and corresponding priorities further comprises:
classifying the training operations entering a cluster and adjusting resources of the training operations; and
determining the priorities of the training operations according to a classification of the training operations and placing the training operations into a queue of training operations.

3. The method for operation resource placement of deep learning of claim 2, wherein the selecting the network structure for operation placement according to required resource amount of the training operations in sequence further comprises:
dividing cluster resources according to the number of network hops to obtain a multi-layer network structure;
extracting, from the queue of training operations, the training operations to be placed according to the priorities; and
selecting, layer by layer, the network structure adapted to the required resource amount of the training operations, based on a resource amount in each layer of the network structure.

4. The method for operation resource placement of deep learning of claim 1, wherein the taking the transmission amount of network data in the training process as the optimization target to perform minimization optimization, and obtaining the corresponding operation placement scheme further comprises:
indicating the transmission amount of network data in the training process based on parameter servers, workers, and the number of parameters of each training operation jointly, and obtaining the optimization target;
establishing an optimization model of the transmission amount of network data based on the optimization target and a capacity of processing resources in a cluster as an optimization constraint; and
based on an optimization result of the optimization model of the transmission amount of network data, assigning the number of the parameter servers and the number of the workers, and processing resources of the parameter servers and processing resources of the workers, to each training operation in the network structure to obtain the operation placement scheme.

5. The method for operation resource placement of deep learning of claim 1, wherein after the obtaining the operation placement scheme, the method further comprises:
when a plurality of training operations share the same processing resource, obtaining a raw time of the training operations by fitting, and obtaining a training time for an entire processing resource by normalization.

6. The method for operation resource placement of deep learning of claim 5, wherein the obtaining the raw time of the training operations by fitting further comprises:
obtaining the raw time by measuring a forward propagation time and a backpropagation time of the training operations and fitting the forward propagation time and the backpropagation time of the training operations in conjunction with a gradient aggregation time.

7. The method for operation resource placement of deep learning of claim 1, further comprising:
establishing an overall scheduling algorithm of the training operations based on the number of remaining services required for the training operations and a capacity of processing resources in a cluster as an optimization constraint; and
periodically traversing processing resources of the training operations based on the overall scheduling algorithm of the training operations and obtaining an optimization result with a minimum number of remaining services.

8. A system for operation resource placement of deep learning, comprising a training operation acquiring module, a priority order placement module, and an operation placement optimization module;
wherein the training operation acquiring module is configured for acquiring training operations to be placed and corresponding priorities;
the priority order placement module is configured for selecting a network structure for operation placement according to required resource amount of the training operations in sequence based on an order of the priorities; wherein the network structure comprises a server, a top of rack, a container group set denoted as Podset, and a trunk layer switch; and
the operation placement optimization module is configured for taking a transmission amount of network data in a training process as an optimization target to perform minimization optimization based on the selected network structure, and obtaining a corresponding operation placement scheme.

9. A computer device, comprising a processor and a memory, wherein a computer program is stored by the memory and executable by the processor to implement the steps of the method for operation resource placement of deep learning of claim 1.

10. A computer-readable storage medium having stored a computer program, wherein the computer program is executed by a processor to implement the steps of the method for operation resource placement of deep learning of claim 1.

11. The computer device of claim 9, the acquiring training operations to be placed and corresponding priorities further comprises:
classifying the training operations entering a cluster and adjusting resources of the training operations; and
determining the priorities of the training operations according to a classification of the training operations and placing the training operations into a queue of training operations.

12. The computer device of claim 11, wherein the selecting the network structure for operation placement according to required resource amount of the training operations in sequence further comprises:
dividing cluster resources according to the number of network hops to obtain a multi-layer network structure;
extracting, from the queue of training operations, the training operations to be placed according to the priorities; and
selecting, layer by layer, the network structure adapted to the required resource amount of the training operations, based on a resource amount in each layer of the network structure.

13. The computer device of claim 9, wherein the taking the transmission amount of network data in the training process as the optimization target to perform minimization optimization, and obtaining the corresponding operation placement scheme further comprises:
indicating the transmission amount of network data in the training process based on parameter servers, workers, and the number of parameters of each training operation jointly, and obtaining the optimization target;
establishing an optimization model of the transmission amount of network data based on the optimization target and a capacity of processing resources in a cluster as an optimization constraint; and
based on an optimization result of the optimization model of the transmission amount of network data, assigning the number of the parameter servers and the number of the workers, and processing resources of the parameter servers and processing resources of the workers, to each training operation in the network structure to obtain the operation placement scheme.

14. The computer device of claim 9, wherein after the obtaining the operation placement scheme, the method further comprises:
when a plurality of training operations share the same processing resource, obtaining a raw time of the training operations by fitting, and obtaining a training time for an entire processing resource by normalization.

15. The computer device of claim 14, wherein the obtaining the raw time of the training operations by fitting further comprises:
obtaining the raw time by measuring a forward propagation time and a backpropagation time of the training operations and fitting the forward propagation time and the backpropagation time of the training operations in conjunction with a gradient aggregation time.

16. The computer device of claim 9, wherein the computer program is executable by the processor to further implement following steps:
establishing an overall scheduling algorithm of the training operations based on the number of remaining services required for the training operations and a capacity of processing resources in a cluster as an optimization constraint; and
periodically traversing processing resources of the training operations based on the overall scheduling algorithm of the training operations and obtaining an optimization result with a minimum number of remaining services.

17. The computer-readable storage medium of claim 10, wherein the acquiring training operations to be placed and corresponding priorities further comprises:
classifying the training operations entering a cluster and adjusting resources of the training operations; and
determining the priorities of the training operations according to a classification of the training operations and placing the training operations into a queue of training operations.

18. The computer-readable storage medium of claim 17, wherein the selecting the network structure for operation placement according to required resource amount of the training operations in sequence further comprises:
dividing cluster resources according to the number of network hops to obtain a multi-layer network structure;
extracting, from the queue of training operations, the training operations to be placed according to the priorities; and
selecting, layer by layer, the network structure adapted to the required resource amount of the training operations, based on a resource amount in each layer of the network structure.

19. The computer-readable storage medium of claim 10, wherein the taking the transmission amount of network data in the training process as the optimization target to perform minimization optimization, and obtaining the corresponding operation placement scheme further comprises:
indicating the transmission amount of network data in the training process based on parameter servers, workers, and the number of parameters of each training operation jointly, and obtaining the optimization target;
establishing an optimization model of the transmission amount of network data based on the optimization target and a capacity of processing resources in a cluster as an optimization constraint; and
based on an optimization result of the optimization model of the transmission amount of network data, assigning the number of the parameter servers and the number of the workers, and processing resources of the parameter servers and processing resources of the workers, to each training operation in the network structure to obtain the operation placement scheme.

20. The computer-readable storage medium of claim 10, wherein after the obtaining the operation placement scheme, the method further comprises:
when a plurality of training operations share the same processing resource, obtaining a raw time of the training operations by fitting, and obtaining a training time for an entire processing resource by normalization.
